(19) United States
(12) Patent Application Publication
(10) Pub. No.: US 2021/0367985 A1
(43) Pub. Date: Nov. 25, 2021

(54) IMMERSIVE TELEPRESENCE VIDEO CONFERENCE SYSTEM

(71) Applicant: Sanjay Bansal, Gurugram (IN)

(72) Inventor: Sanjay Bansal, Gurugram (IN)

(21) Appl. No.: 16/497,290

(22) PCT Filed: Mar. 22, 2019
(86) PCT No.: PCT/IB2019/052332

§ 371 Date: Sep. 24, 2019

(30) Foreign Application Priority Data
Mar. 23, 2018 (IN) 201811010763

(51) Int. Cl. H04L 29/06; H04N 5/247; G06F 3/14

(52) U.S. Cl. CPC H04L 65/403; G06F 3/1454; H04N 5/247

(57) ABSTRACT

A video conferencing system (100) for conducting meeting of a number of participants (108) is provided. The system (100) includes a conference table (104) having a base side (202) and first side edge (204) forming an arcuate segment (208) with the base side (202). The system (100) includes a display screen (106), a first video capturing device (112) and a second video capturing device (112). The display screen (106) is positioned in proximity to the base side (202). The first video capturing device (112) is positioned over the display screen (106) to capture one or more participants (108) seated on the conference table (104). The second video capturing device (112) is positioned over the display screen (106) to capture one or more participants (108) seated on the base side (202) and the first side edge (204) of the conference table (104). A processor (806) is operatively coupled to the display screen (106) and the first and the second video capturing devices (112). The processor (806) is configured to display content presentations and video of one or more participants (108).

### TECHNICAL FIELD

The present disclosure generally relates to a telepresence conference system and a method thereof. More particularly, the present disclosure relates to an immersive telepresence video conference system and a method thereof.

### BACKGROUND

As the global economy continues to expand, the need to effectively communicate over distances also arises. In such cases, video conference is an established method of communication between remotely located participants. In its basic form, a video image of a remote participant/environment is broadcast onto a local monitor allowing a local participant to view and conversate with one or more remotely located participants. Telepresence is a videoconferencing service that provides a virtual, face-to-face meeting experience. In an extension to it, immersive telepresence videoconference environments attempt to simulate the experience of a face-to-face interaction for participants and creates the illusion that a plurality of participants, who are typically remote from each other, occupy the same virtual space.

Implementation of telepresence systems typically require a dedicated room specifically designed for high-end videoconferencing, which is achieved with the help of high definition cameras, high end screens and networking technologies. Furthermore, the room size requirement is very large, and implementation requires a separate conference room and additional installation overhead. For example, in conventional immersive telepresence video conference systems, 500 square feet of space has to be dedicated only for conducting telepresence video conference, which remains completely unutilized during 70% of the typical room usage i.e. for local meeting. Further, conventional telepresence systems are also limited by use of standard 3 screen telepresence systems and have a 3-screen assembly having 3 screens of 65″ to 84″ in the front, a table to seat 6-9 participants, an elaborate audio system and some kind of content screen using 4th screen or on table content monitors. These rooms require a space of approximately 25′×20′ along with detailed acoustic and lighting treatment in the room for a 6-seating capacity making telepresence room technology installation quite expensive.

Furthermore, in a conventional immersive telepresence video conference environment, local participants do not get the same table same room experience as the table at the remote site appears to be of more height than the local site table. This is because the distance between the local participants and the screen, on which image of remote site participants is displayed, is approximately 10 inches or higher. This difference in the height of the remote site table and local site table makes remote participants and local participants feel that they are sitting on different tables. Further, the participants on the local site may interact face to face only with remote site participants and not with the local participants present in the same room.

Also, most of the conventional immersive telepresence video conference systems are based upon the assumption that the remote site people should be visible in true life size for immersive meeting experience. However, a simple fact that has been ignored by all the telepresence system makers, is that, visualized size by the participant is also a function of distance between the screen and the observer and not just the size of the screen.

### SUMMARY

In an aspect of the present disclosure, a video conferencing system for conducting conference meeting of one or more participants is provided. The system includes a conference table having a base side and a first side edge forming an arcuate segment with the base side. The system further includes at least one display screen, at least one first video capturing device and at least one second video capturing device. The at least one display screen is positioned in proximity to the base side of the conference table. The at least one first video capturing device is positioned over the at least one display screen and configured to capture one or more participants seated on the conference table. The at least one second video capturing device is positioned over the at least one display screen and configured to capture one or more participants seated on the base side and the at least one side edge of the conference table. The system further includes a processor operatively coupled to the at least one display screen and the first and the second video capturing devices. The processor is configured to display, on the display screen, one or more of content presentations, and video of one or more participants captured by one or more of the at least one first video capturing device and the at least one second video capturing device.

### BRIEF DESCRIPTION OF THE DRAWINGS

The following is a brief description of the various embodiments with reference to the accompanying drawings. It is to be understood that the features illustrated in and described with reference to the drawings are not to be construed as limiting the scope of the invention. In the accompanying drawings:

FIG. 1 illustrates an exemplary immersive telepresence video conference system in accordance with an embodiment of the present disclosure;

FIG. 2 illustrates a top view of the exemplary immersive telepresence video conference system of FIG. 1, in accordance with the embodiment of the present disclosure;

FIG. 3 illustrates an exemplary immersive telepresence video conference system in accordance with an alternative embodiment of the present disclosure;

FIG. 4 illustrates an exemplary immersive telepresence video conference system in accordance with a yet another embodiment of the present disclosure;

FIG. 5 illustrates an exemplary immersive telepresence video conference system in accordance with a yet another embodiment of the present disclosure

FIG. 6 illustrates an exemplary system for immersive telepresence conference in accordance with a yet another embodiment of the present disclosure;

FIG. 7 illustrates a top view of an exemplary immersive telepresence video conference system in accordance with an alternative embodiment of the invention; and

FIG. 8 illustrates a block diagram for a communication system for conducting immersive telepresence video conference amongst two or more separate conference rooms, according to the various embodiments of the present disclosure.

### DESCRIPTION

Reference will now be made in detail to embodiments of the present disclosure, examples of which are illustrated in the accompanying drawings. Wherever possible, the same reference numbers will be used throughout the drawings to refer to the same or like parts.

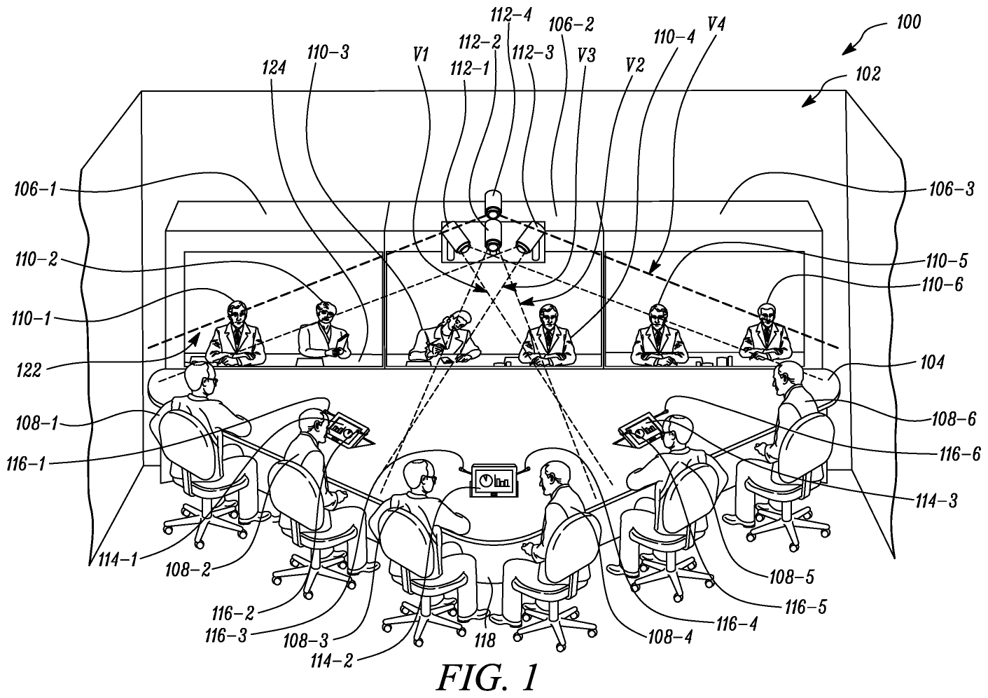

The present disclosure relates to an immersive telepresence video conference system and a method that enables and enhances the immersive telepresence video conference experience. Referring to FIG. 1, an exemplary immersive telepresence video conference system 100 (hereinafter referred to as the system 100) is described. The system 100 may be positioned inside a conference room 102. The system 100, according to the various embodiments of the present disclosure, provides an enhanced immersive telepresence experience for local as well as remote users participating in a video conference with one another. The system 100 also provides an enhanced local meeting experience for users located within the same conference room, such as in the conference room 102 allowing the system to be used for local meetings.

In an exemplary embodiment, the system 100 includes a conference table 104 (hereinafter referred to as the table 104), one or more display screens 106, one or more local users 108, one or more remote users 110, one or more video capturing devices 112 and one or more content monitors 114 positioned on the table 104. Further, the system 100 may also include one or more microphones 116 positioned on the table 104 and proximal to the local users 108 sitting in the room 102.

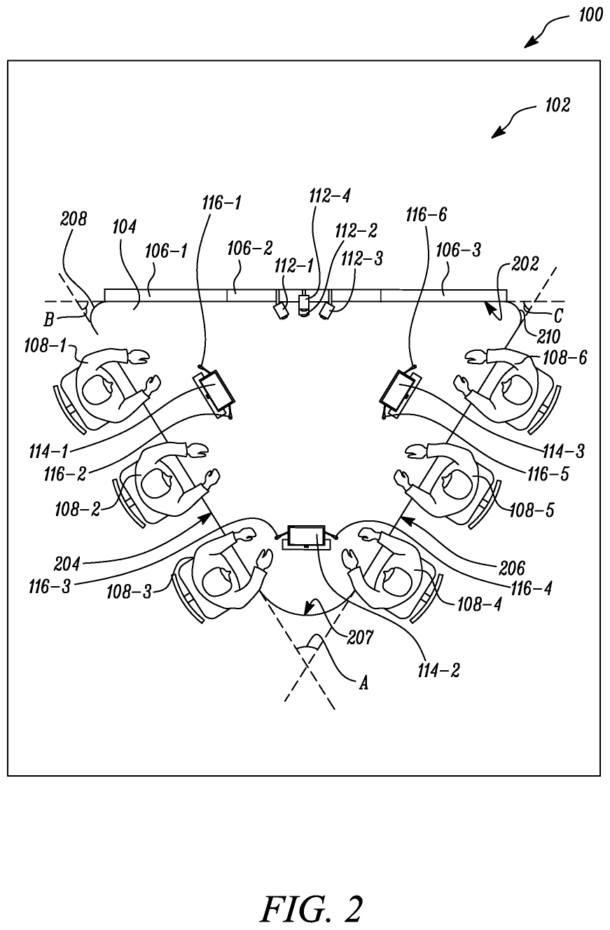

In an embodiment of the present disclosure, the table 104 includes a triangular profile with circular ends, as shown in FIGS. 1 to 7. The table 104 may include a base side 202, a first side edge 204 and a second side edge 206, as shown in FIG. 2. The first side edge 204 and the second side edge 206 form an angle A and define a first arcuate segment 207 of the table 104. Similarly, the first side edge 204 and the base side 202 form an angle B and define a second arcuate segment 208. Furthermore, the second side edge 206 and the base side 202 form an angle C and define a third arcuate segment 210. In an exemplary embodiment, values of the angles A, B and C may be within a range of 40 degrees to 70 degrees. It may be contemplated that the values of the angles are merely exemplary and may be varied to achieve similar results.

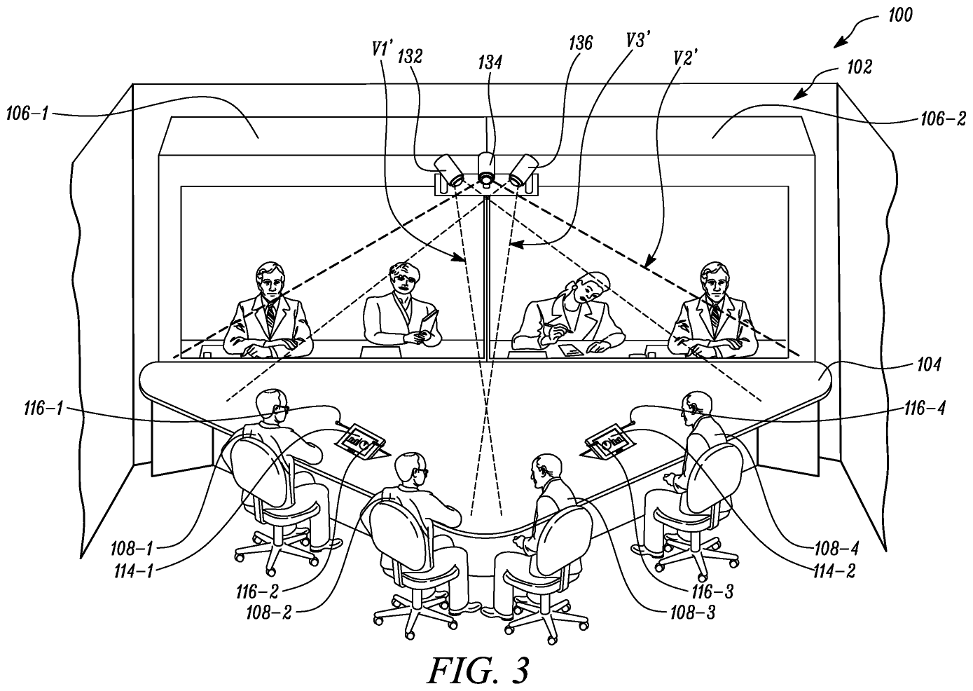

Further, as shown in FIGS. 1 to 7, the table 104 may accommodate one or more local users 108 that may be seated around the table 104 during either a local meeting or a video conference meeting. As shown in FIGS. 1 to 7, the table 104 may accommodate 4 local users, 6 local users, and may be extended up to 24 local users according to the size of the table 104. For example, as shown in FIG. 1, the table 104 accommodates 6 local users 108, such that three local users 108-1, 108-2, 108-3 are seated along the first side edge 204 and three local users 108-4, 108-5 and 108-6 are seated along the second side edge 206. In another example, as shown in FIG. 3, the table 104 may accommodate 4 local users 108 such that two local users 108-1 and 108-2 are seated along the first side edge 204 and two local users 108-3 and 108-4 are seated along the second side edge 206. Although, FIGS. 1 to 7 show only 4 and 6 local users 108, it may be understood, that the number of local users may be increased or decreased depending on the requirement, without deviating from the scope of the claimed subject matter. Further, in an embodiment, the table 104 includes a housing 118 positioned beneath the table 104. The housing 118 is configured to house a number of wires and connections of one or more components of the system 100.

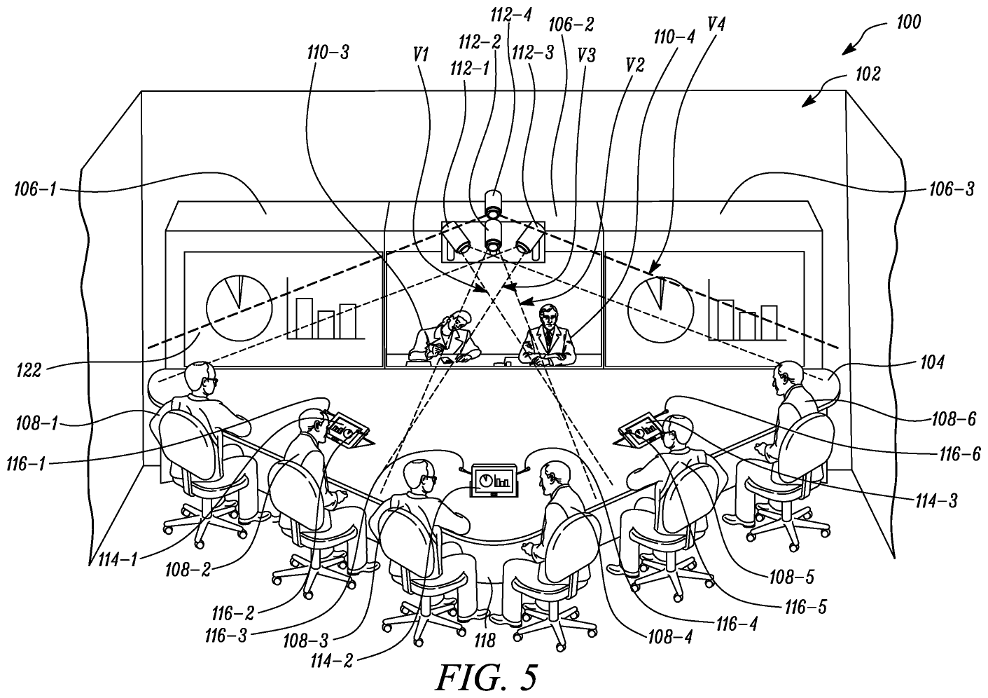

Further, the system 100 includes one or more display screens 106 configured to display one or more of content, remote users 110 or other remotely located conference rooms 122, 124. In an embodiment, the system 100 includes three display screens, such as a first display screen 106-1, a second display screen 106-2, and a third display screen 106-3. As shown in FIGS. 1 to 4, where the system 100 includes three display screens 106, the display screens 106-1, 106-2, 106-3 are positioned in line and adjacent to one another. It may be contemplated that the number and arrangement of display screens 106 is also exemplary and may be varied to achieve similar results. For example, in an alternative embodiment, the system 100 may include only two display screens, such as display screens 106-1 and 106-2, as shown in FIG. 3. In such a case, the display screens 106-1 and 106-2 may be positioned in line and adjacent to one another. Further, in a yet another embodiment, the system 100 may include four screens, such as display screens 106-1, 106-2, 106-3 and an additional fourth display screen 106-4, as shown in FIG. 5. In such a case, the display screens 106-1, 106-2, 106-3 may be positioned in line and adjacent to one another and the fourth screen 106-4 may be positioned over the center screen, i.e., the second display screen 106-2.

In an exemplary embodiment of the present disclosure, a lower end 120 of the display screens 106 is positioned at a height equal to or less than a height of the table 104 with respect to the ground. Additionally, according to the various embodiments of the present disclosure, size of the display screens 106 is adjusted according to the dimensions of the table 104. For example, for a smaller size of the table 104, by virtue of its triangular profile with the circular ends, a smaller screen size is used for the display screens 106 in order to maintain the eye to eye contact between the local users 108 and the displayed remote users 110. This is because, for a smaller size of the table 104, a distance between the local users 108 and the display screens 106 decreases. Therefore, in order to provide an immersive telepresence experience, the sizes of the display screens 106 are also reduced as a function of the distance between the users 108 and the display screens 106, i.e., the dimension or length of the table 104. In an exemplary embodiment, the display screens 106 are of 43 inches or 49 inches size.

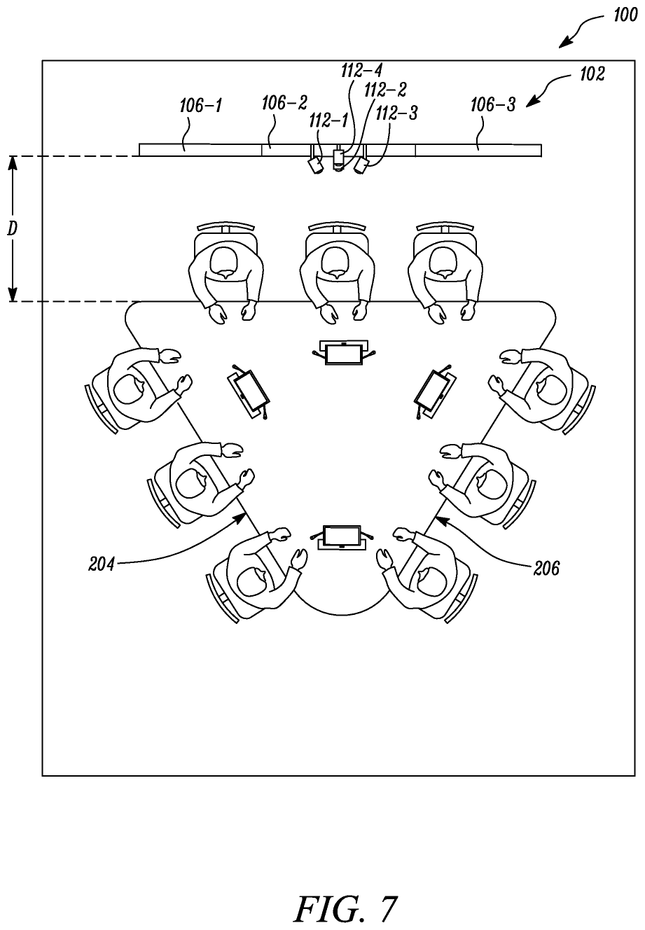

As shown in FIGS. 1 to 6, the display screens 106 are attached to the table 104. In one example, the display screens 106 may be directly attached to the base side 202 of the table 104. In another example, the table 104 may include a downward slope segment (not shown) extending between the base side 202 and the lower end 120 of the display screens 106. The downward slope may be based on a desired height of the display screens 106 in order to achieve an eye to eye contact between the local users 108 and the remote users 110 displayed on the display screens 106. In an alternative embodiment, as shown in FIG. 7, the display screens 106 may not be attached to the table 104 and positioned at a predefined distance D from the base side 202 of the table 104. In such an embodiment, the system 100 also provides for a provision of accommodating more local users 108 that may be seated along the base side 202 of the table 104. Accordingly, for local meetings, local users 108 may sit on all the sides of the table 104, and for a video conference, no local users 108 may sit along the base side 202 to provide clear visuals of the display screens 106. In an embodiment, the display screens 106 may be mounted on a portable wall having a housing defined therein to accommodate the wires and connections of the display screens 106 with the various components of the system 100.

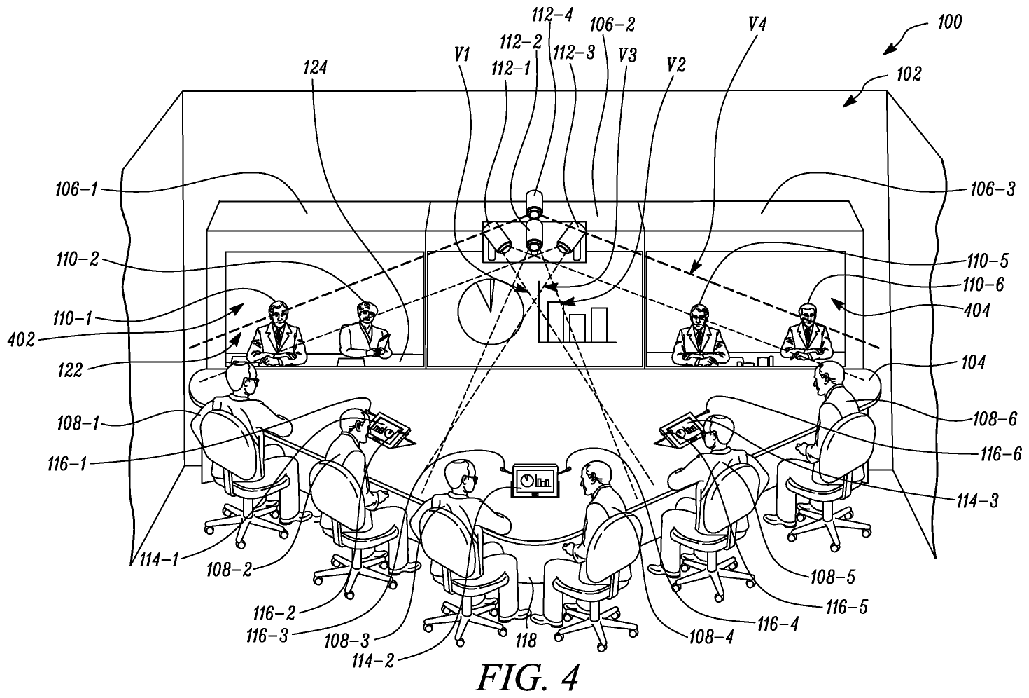

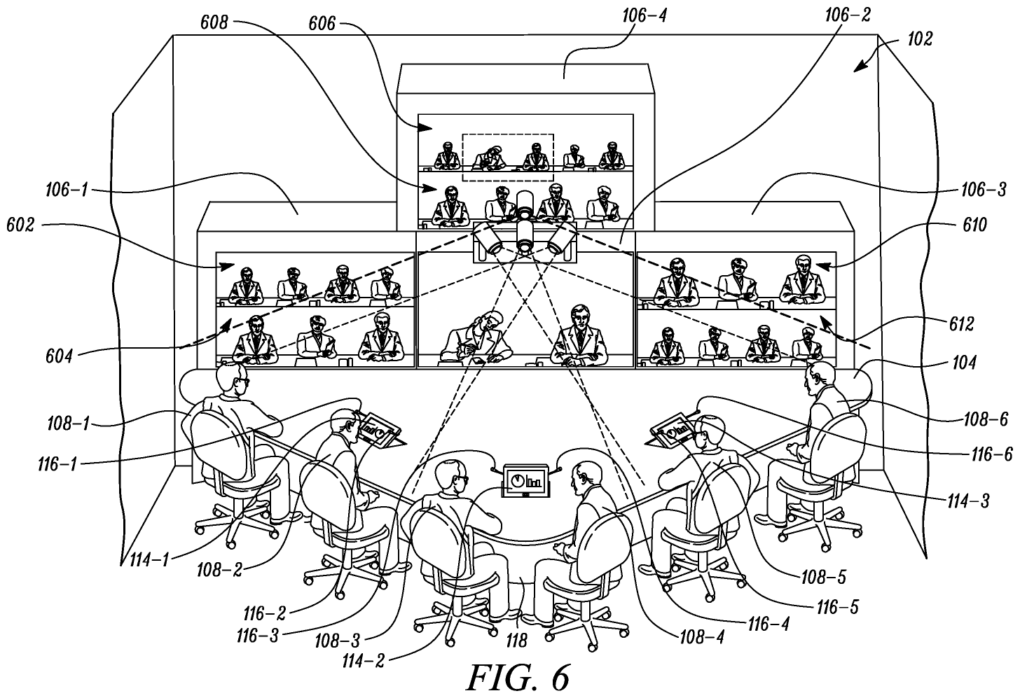

Each of the display screens 106 is configured to display one or more of content, presentations, remote users 110, local users 108, speakers, etc., from one or more remote locations. Further, each of the display screens 106 may act individually or in combination with one or more of the other display screens 106. In one example, as shown in FIG. 1, the three display screens 106-1, 106-2, and 106-3 may act in combination to provide a combined large display for displaying one remotely located conference room 122 and the remote users 110-1, 110-2 . . . 110-6 sitting on a remotely located conference table 124 in the conference room 122. In a second example, as shown in FIG. 4, two remotely located conference rooms 402 and 404 may be connected and displayed on the two display screens, such as the display screen 106-1 and 106-3 and the content or presentation presented in the conference may be displayed on the center screen 106-2. In a third example, as shown in FIG. 5, the center screen 106-2 may display a speaker in focus, in life size, amongst the remote users 110 from the remotely located conference room 122 or from the local users 108, and the display screens 106-1 and 106-3 may display the content and/or the presentation presented in the video conference. In a fourth embodiment, as shown in FIG. 6, where the system 100 includes four display screens 106-1, 106-2 . . . 106-4, multiple remotely located conference rooms, i.e., conference rooms 602, 604, 606 . . . 612, may be displayed on the display screens 106-1, 106-2, 106-3, and 106-4 and the speaker, such as a speaker located in remote conference room 606, may also be displayed, additionally in focus on one of the display screens 106, such as the screen 106-2. Furthermore, a single display screen 106 amongst the display screens, may display multiple remotely located conference rooms by dividing the screen space accordingly. Accordingly, a single local conference room 102 may be connected to multiple remotely located conference rooms using the system 100 of the present disclosure. It may be contemplated that the above-mentioned arrangement of content, presentation and remotely located conference rooms and users is merely exemplary and that any other combination and arrangement of the display screens 106 may also be visualized without deviating from the scope of the claimed subject matter.

In a further embodiment of the present disclosure, the system 100 includes one or more video capturing devices 112 positioned over the display screens 106, as shown in FIGS. 1 to 7. Examples of the video capturing devices 112 may include, but not limited to, a manual or automatic video camera, a single or multiple lens camera, having a wide angle optical viewing range. In the embodiment of the system 100 including three displays 106, the system 100 also includes four video capturing devices, such as a first camera 112-1, a second camera 112-2, a third camera 112-3 and a fourth camera 112-4 positioned on top of the center display screen 106-2. In an embodiment, where the number of display screen 106 is limited to two, the system 100 includes three video capturing devices, such as first camera 112-1, second camera 112-2 and third camera 112-3 positioned on top of the center display screen 106-2. Although, embodiments with only three and four video capturing devices are shown and described herein, it may be contemplated that the number and type of video capturing devices 112 is merely exemplary and may be varied to achieve similar results.

Each of the video capturing devices 112 may have its own field of view and may be configured to capture an image or video of the conference room 102, or the local users 108 according to their respective field of view. For example, the video capturing device 112 positioned at the center, i.e., the fourth video capturing device 112-4 may have a field of view V4 such that it is configured to capture the entire conference room 102 along with the conference table 104 and all the local users 108. In an exemplary embodiment, the first video capturing device 112-1, the second video capturing device 112-2 and the third video capturing device 112-3 may be positioned such that they have a respective field of view V1, V2 and V3, as shown in FIG. 1 to capture the local users 108 sitting on the diagonally opposite side on the table 102. For example, the first video capturing device 112-1 may be configured to capture the local users 108-5, and 108-6 positioned on the second side edge 206 of the table 102. Further, the second video capturing device 112-2 may be configured to capture the local users 108-3 and 108-4 positioned on the circular end of the triangular table 102. Similarly, the third video capturing device 112-3 may be configured to capture the local users 108-1 and 108-2 positioned on the first side edge 204 of the table 102. Similarly, the system 100 having three video capturing devices 112-1, 112-2, and 112-3 (as shown in FIG. 3) may have their respective field of views V1′, V2′ and V3′ and may be configured to view the local users positioned in their respective field of views.

In an embodiment of the present disclosure, the video capturing devices 112 are positioned at a height which is adjusted according to one or more parameters associated with the table 104, the local users 108 and the area of the local conference room 102. For example, as explained previously, the screen sizes are reduced according to the dimensions of the table 104 and therefore, the height of the video capturing devices 112 are also accordingly adjusted to provide an eye to eye contact amongst the local users 108 and the remote users 110 displayed on the display screens 106. The video capturing devices 112 are positioned on a top end of the center display screen 106-2. Since the size of the screen 106-2 is smaller and the position of the lower end of the display screen 106-2 is affixed to the base side 202 of the table 104, the height at which the top end of the screen 106-2 is positioned is also accordingly lowered, thereby lowering the position of the video capturing devices 112. Such a setup of the display screens 106 and the video capturing devices 112 provides an eye to eye contact between the remote users 110 and the local users 108 and consequently provides an enhanced immersive telepresence experience.

The system 100 includes a number of content monitors 114 positioned on the table 104. In an embodiment, the system 100 includes three content monitors 114-1, 114-2 and 114-3 positioned on the table 104 for the local users 108 sitting on the table 104. For example, there may be one content monitor placed on the table 104 for every two local users sitting beside one another. As shown in the figures, the first content monitor 114-1 may be placed between the first local user 108-1 and the second local user 108-2. Similarly, one content monitor may be placed between the local users 108-3 and 108-4 and another content monitor may be placed between the local users 108-5 and 108-6. The content monitors 114 may be configured to display the content and/or presentation being presented or discussed in the video conference. The content monitors 114 may also perform display and interaction functionalities, which are not described herein details for the sake of brevity of the disclosure. One such interaction functionality performed by the content monitors 114 may be the “look at me” function, which facilitates the local user to focus the video capturing devices on to him/her when he/she is speaking in the meeting. This means, that as the user activates the “look at me” function then the corresponding video capturing device may zoom in to that user and accordingly, the speaker is displayed on to the display screen. The “look at me” function may be performed in a standard manner, known in the art and therefore is not described herein detail. It may also be understood by a person skilled in the art that the “look at me” function may alternatively be performed by a specific switch provided on the table 104 or elsewhere instead of the content monitors 114.

In an exemplary embodiment, the table 104 may include a number of slots (not shown) formed therein to facilitate positioning of the content monitors 114 on the table 104. The content monitors 114 may be positioned such that they may be completely retracted within the table 104, such as within the housing 118 of the table 104, when not in use. Whereas, the content monitors 114 may be extracted out of the table 104, as and when required for the meeting. In one example, the retraction and extraction of the content monitors 114 may be accomplished manually, by use of a mechanical lever, not shown. In an alternative example, the retraction and extraction of the content monitors 114 may be accomplished automatically, by use of switches and buttons. Furthermore, the content monitors 114 are pivotable to a desired angle with respect to the table 104, according to the position of the respective local user 108. This means that the local user may adjust the angle and position of the content monitors 114 to have a clear view of the content monitor 114 which is glare free and at the same time, have an obstruction free view of the display screens 106. The content monitors 114 may also facilitate the local users 108 as well as the remote users 110 to annotate on the displayed presentation or content. This facilitates the users, both local and remote to be more interactive on the conference by annotating their questions and/or explanations on their respective content monitors 114 itself, without having to ask and explain the presenter to do so. The annotated content is then displayed on all the other content monitors 114 and the display screens 106 where the presentation is displayed. In order to do so, the local user 108 has to activate the annotation mode on the content monitor 114 by double tapping on the respective content monitor 114 and start annotating on the content.

As explained previously, the system 100 also includes a number of microphones 116 positioned on the table 104 corresponding to every local user 108 sitting therein. Alternatively, there may be only one microphone 116 positioned in the center of the table 104 instead of having an individual microphone for every local user. The microphones 116 may be a part of a standard audio system configured to transmit the audio of the local conference room 102 to the remote conference room 122. The audio system may also include speakers and other components, conventionally known in the art. The audio system is not described herein in greater detail for the sake of brevity of the disclosure.

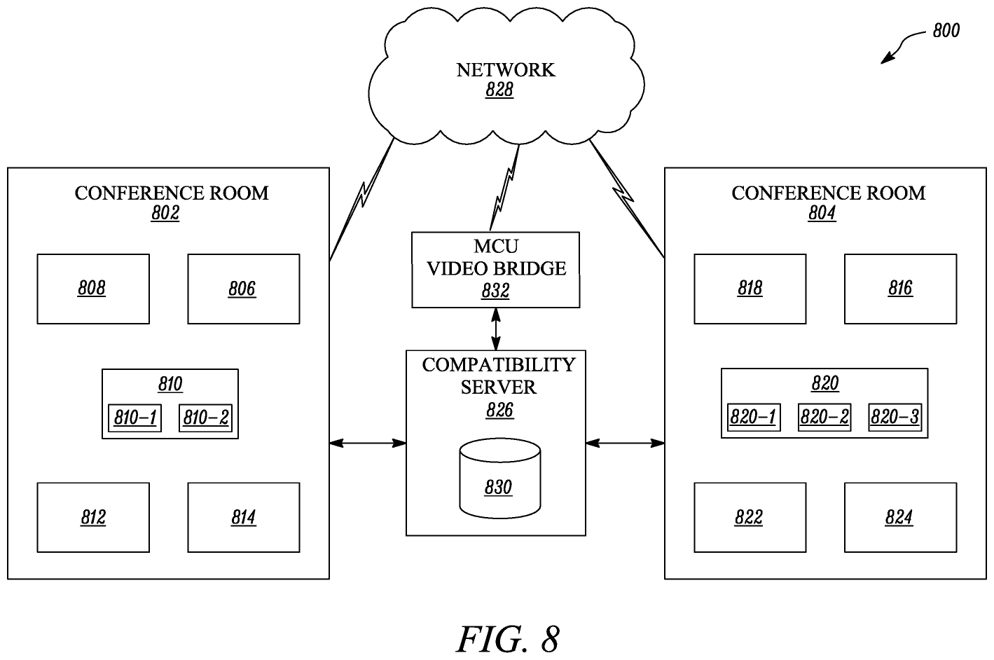

FIG. 8 illustrates a block diagram of a communication system 800 for providing immersive telepresence video conferencing between a first conference room 802 and a second conference room 804. In an embodiment, one or more of the first and the second conference rooms 802 and 804 may be implemented as the conference room 102 and may include their respective immersive telepresence video conferencing system 100, as described in conjunction to FIGS. 1 to 7. Further, each of the conference rooms 802 and 804 may also act as remote conference room with respect to the other one.

As shown in FIG. 8, the first conference room 802 includes a processor 806, a set of microphones 808 (similar to the microphones 116), one or more display screens 810 (similar to the display screens 106), one or more content monitors 812 (similar to the content monitors 114) and one or more video capturing devices 814 (similar to the video capturing devices 112). In one example, the second conference room 804 may also be implemented in similar configuration as the first conference room 802. In this case, the second conference room 804 may include a processor 816, a set of microphones 818, one or more display screens 820, one or more content monitors 822 and one or more video capturing devices 824. However, in an alternative embodiment, the second conference room 804 may have a different configuration than the first conference room 802. One of the differences between the first conference room 802 and the second conference room 804 may be that the first conference room 802 includes 2-display screens 810-1, 810-2, whereas the second conference room 804 may include 3-display screens 820-1, 820-2, and 820-3, as shown in FIG. 8.

The communication system 800 includes a compatibility server 826 configured to communicate with the processor 806 of the first conference room 802, the processor 816 of the second conference room 804 and an MCU (Multipoint Control Unit) video bridge 832 (hereinafter referred to as video bridge 832). The roles and responsibilities of the compatibility server 826 are further described in greater detail in the following paragraphs of the description. In an exemplary embodiment, the communication system 800 may be implemented on a network 828. The network 828 may be a Local Area Network (LAN), Wide Area Network (WAN) and/or Internet. It may be understood by a person skilled in the art, that the compatibility server 826 may be a stand-alone entity implemented on the network 828 or may be implemented within the respective systems 100 implemented within the conference rooms 802 and/or conference room 804.

In operation, the first conference room 802 may include 6 local users seated therein for a local meeting. The display screens 810-1, 810-2 may display a presentation being presented within the conference room 802 during the local meeting. For the local meeting, the content monitors 812 may or may not be used by the local users of the conference room 802 to display the presentation being displayed on the display screens 810-1, 810-2. In an alternative embodiment, the content monitors 812 may be solely used to display the presentation and/or content being discussed in the local meeting and the display screens 810 may be switched off. During the local meeting, the processor 806 may communicate the presentation and/or the content to be displayed, with one or more of the content monitors 812 and the display screens 810.

In an embodiment, the conference room 802 may also be used for a video conference with remotely located users sitting in the remotely located conference room 804. In such a scenario, a user sitting in the conference room 802 dials to the conference room 804 to conduct the video conference. The dialing is done via the compatibility server 826. Further, the compatibility server 826 receives information about the dialer, i.e., the conference room 802 and the information about the receiver, i.e., the conference room 804. In an exemplary embodiment, the compatibility server 826 may also include a database 830 configured to store data associated with the conference rooms 802, and 804. Upon receiving the call from conference room 802, the compatibility server 826 extracts information about the conference room 802 as well as the information about the receiving party, i.e., the conference room 804, from the database 830. In case, where the configuration of the dialer and the receiver are same, the compatibility server 826 will ask the video bridge 832 to connect the call directly. However, in case the configuration of the two conference rooms are different, then the compatibility server 826 connects the two conference rooms through compatibility mode by giving different instruction to the video bridge 832 as well as 3 screen telepresence system.

### Direct Connection:

When conference room 804 includes 2 display screens 810-1, 810-2 and two codecs, and the conference room 804 also includes 2 display screens, and two-codecs, then the compatibility server 826 asks the video bridge 832 to directly connect the two conference rooms 802, 804 in the native mode and the video conference begins.

### Compatibility Mode:

In the illustrated example, the conference room 802 includes 2-display screens, 810-1, 810-2 and the conference room 804 includes 3-display screens, 820-1, 820-2, and 820-3. Accordingly, the first conference room 802 would include 2 codecs and the second conference room 804 would include 3-codecs. Therefore, the compatibility server 826 would ask the video bridge 832 to connect the receiver, according to the dialer's configuration. Accordingly, the compatibility server 826 converts the video capturing devices 824, the codecs and the display screens 820 of the second conference room 804 to match with the configuration of the first conference room 802. Such converting of the configuration of a three-display screen, 3-codec conference room 804 to match with the configuration of the two-display screen, and 2-codecs conference room 802 provides seamless, highly immersive and astigmatism free telepresence video conferencing system.

Once the two conference rooms 802, 804 are connected, the video capturing device 814 of the conference room 802 starts sending video feeds of the conference room 802 and/or the speaker amongst the local users, to the processor 806. The processor 806 further communicates the video feeds from the video capturing device 814 to the processor 816 of the second conference room 804 via the compatibility server 826 and in turn display the video feeds on the display screens 820. Similarly, video feeds of the second conference room 804 and/or the speakers amongst the local users of the conference room 804, captured by the video capturing device 824 may be communicated to the processor 806 of the first conference room 802 and displayed on the display screens 810. Further, the video capturing device 824 may also coordinate with the microphones 808 and/or the “look at me” switch provided on the content monitors 114 or elsewhere to identify a speaker in the conference and accordingly focus on the speaker to display on the display screens, if desired.

It may be contemplated that any one or more local or remote users within the conference rooms 802, 804 may share one or more content and/or presentations to be discussed in the video conference. The content and/or the presentation may be subsequently displayed on the other display screen and/or the content monitors of the conference rooms 802, 804 as desired. As described previously, the configuration and arrangement of the display screens, the content monitors etc., to display the users and/or the content may be varied according to the requirements and desires of the users participating in the video conference.

### INDUSTRIAL APPLICABILITY

The immersive telepresence video conference system 100 of the present disclosure provides a modular system, that may be implemented in any existing ordinary conference room and convert the ordinary room into immersive telepresence video conference room. Additionally, the system 100 may be used for both local meeting experiences and immersive telepresence video conference experiences, instead of having two separate setups in two separate conference rooms, as done conventionally.

Further, the profile of the table 104, according to the embodiments presented herein, provides a compact system which uses smaller display screens to provide highly efficient immersive telepresence experience to the local users 108 as well as the remote users 110. Furthermore, since all the wires and connections are housed within the housing 118 of the table 104 and housing within the portable walls of the display screens 106, the system 100 becomes a portable, and an in-a box setup, which can be easily installed at any location. Further, the housing 118 also improves the aesthetics of the system 100 as no connection wires are visible either to local users or remote users. The smaller size of the table 104, the display screens 106 and consequently the system 100 consequently require a smaller space rooms for installation.

The profile of the table 104 further provides an enhanced local meeting experience by eliminating cold shouldering amongst local users, thereby facilitating an improved face to face interaction amongst the local users 108. Additionally, the profile of the table 104, such as the triangular profile with circular ends, the downward slope segment, the arcuate segments 207, 208, 210 provide special aesthetic dimensions to the table 104 and the entire system 100. The smaller design of the table also provides enhanced audio reception for the remote users 110, which removes the need for modification of room acoustics.

Additionally, connection of table 104 with the display screens 106 at a lower height increases the impressiveness and creates an illusion between remote site participants and local participants, as if they are sharing the same table. The connection of display screens 106 to the downward slope segment of the table 104, along with reduced height and size of the display screens 106 ultimately reduces the position of the video capturing devices 112 installed at the top of the display screens 106. The lower installation of the video capturing devices 112 is done such that the position of the video capturing device 112 matches a height of the local users 108 whose eyes are typically at 4″ level from the ground. This gives an enhanced eye to eye contact, with lowest parallax error, between the local users 108 and the remote users 110 displayed on the display screens 106.

Furthermore, the system 100 facilitates implementing video conferencing with multiple remote locations, such as up to 54 different locations, that include up to 720 participants.

While aspects of the present disclosure have been particularly depicted and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

### ELEMENT LIST

100 System
102 Conference Room
104 Table
106 Display Screens
108 Local User
110 Remote Users
112 Video Capturing Device
114 Content Monitor
116 Microphone
118 Housing
120 Lower End of the Display Screen
122 Remotely Located Conference Room
124 Remotely Located Conference Table
202 Base Side of the Table 104
204 First Side Edge of the Table 104
206 Second Side Edge of the Table 104
207 First Arcuate Segment
208 Second Arcuate Segment
210 Third Arcuate Segment
402 Remote Conference Room
404 Remote Conference Room
602 Remote Conference Room
604 Remote Conference Room
606 Remote Conference Room
608 Remote Conference Room
610 Remote Conference Room
612 Remote Conference Room
800 Communication System
802 First Conference Room
804 Second Conference Room
806 Processor
808 Microphones
810 Display Screens
812 Content Monitors
814 Video Capturing Device
816 Processor
818 Microphones
820 Display Screens
822 Content Monitors
824 Video Capturing Device
826 Compatibility Server
828 Network
830 Database
832 MCU Video Bridge
A,B,C Angles
V1, V2, V3, V4 Field of views
V1′, V2′ V3′ Field of views
D Distance Between Display Screen 106 and Table 104

I claim:

1. A video conferencing system (100) for conducting conference meeting of one or more participants (108), the video conferencing system (100) comprising:
a conference table (104) having a base side (202) and a first side edge (204) forming an arcuate segment (208) with the base side (202);
at least one display screen (106) positioned in proximity to the base side (202) of the conference table (104);
at least one first video capturing device (112) positioned over the at least one display screen (106) and configured to capture one or more participants (108) seated on the conference table (104);
at least one second video capturing device (112) positioned over the at least one display screen (106) and configured to capture one or more participants (108) seated on the base side (202) and the first side edge (204) of the conference table (104); and
a processor (806) operatively coupled to the at least one display screen (106) and the at least one first and second video capturing devices (112), the processor (806) being configured to:
display, on the at least one display screen (106), one or more of content presentations, and video of one or more participants (108) captured by one or more of the at least one first video capturing device (112) and the at least one second video capturing device (112).

2. The video conferencing system (100) as claimed in claim 1, wherein the first side edge (204) forms an angle with the base side (202), and wherein the conference table (104) includes a second side edge (206) forming an angle and an arcuate segment (207, 210) with each of the base side (202) and the first side edge (204).

3. The video conferencing system (100) as claimed in claim 1, wherein the at least one display device (106) defines a lower end (120) positioned at a height equal to or less than a height of the conference table (104).

4. The video conferencing system (100) as claimed in claim 1, wherein the processor (806) is configured to communicate with a remotely located second processor (816) of a second video conferencing system (804), and wherein the processor (806) is further configured to display, on the display screen (106), one or more video feeds from a remote video capturing device positioned within the second video conferencing system (804).

5. The video conferencing system (100) as claimed in claim 1 further comprising one or more content monitors (114) positioned on the conference table (104) and configured to display one or more of content and presentation and receive one or more user inputs.

6. The video conferencing system (100) as claimed in claim 5, wherein the processor (806) is communicatively coupled to the one or more content monitors (114), and wherein the processor (806) is further configured to receive the content and presentation displayed on the one or more content monitors (114) and display, on the at least one display screen (106) the one or more of content and presentation received from the content monitors (114).

7. The video conferencing system (100) as claimed in claim 5, wherein the conference table (104) includes a housing (118) and wherein the one or more content monitors (114) are retractably positioned within the housing (118) of the conference table (104).

8. The video conferencing system (100) as claimed in claim 1, wherein the at least one second video capturing device (112) is configured to focus on one of the participants (108) seated on the conference table (104) and wherein the processor (806) is configured to:
display, on the at least one display screen (106), video of the focused participant (108) seated on the conference table (104) or a video of remotely located focused participant (110) seated on a conference table of a remotely located second video conferencing system (804).

9. A communication system (800) for a video conferencing setup comprising:
a first video conferencing system (802) as claimed in claim 1 and having the first processor (806) and a second video conferencing system (804) having a second processor (816) communicatively coupled to the processor (806) of the first video conferencing system (802);
a compatibility server (826) communicatively coupled to the processor (806) and the second processor (816); and
a video bridge (832) communicatively coupled to the compatibility server (826) and the processor (806) and the second processor (816), the video bridge (832) and the compatibility server (826) being configured to communicatively connect the first video conferencing system (802) with the second video conferencing system (804).

10. The communication system (800) as claimed in claim 9, wherein the compatibility server (826) is configured to adjust a configuration of the second video conferencing system (804) based on a configuration of the first video conferencing system (802).
